(19) United States
(12) Patent Application Publication
(10) Pub. No.: US 2019/0034206 A1
(43) Pub. Date: Jan. 31, 2019

(54) TECHNIQUES TO MITIGATE HIGH LATENCY INSTRUCTIONS IN HIGH FREQUENCY EXECUTION PATHS

(71) Applicants: Harshad Sane, Portland, OR (US); Kshitij Doshi, Tempe, AZ (US)

(72) Inventors: Harshad Sane, Portland, OR (US); Kshitij Doshi, Tempe, AZ (US)

(21) Appl. No.: 15/825,183

(22) Filed: Nov. 29, 2017

(51) Int. Cl. G06F 9/38; G06F 11/34; G06F 9/30

(52) U.S. Cl. CPC G06F 9/3836; G06F 9/30079; G06F 9/30145; G06F 11/3419

(57) ABSTRACT

Embodiments may be directed to techniques to execute a binary based on source code comprising basic blocks of instructions, identify a path of execution of a plurality of the basic blocks of instructions having a higher execution frequency than an execution frequency threshold, and collect last branch records for the plurality of the basic blocks of instructions, the last branch records to indicate times of execution for the plurality of the basic blocks of instructions. Further, embodiments include determining latency values for each of the plurality of the basic blocks of instructions based on the times of execution, and performing a mitigation operation for each of the plurality of the basic blocks of instruction having latency values above a latency threshold.

### TECHNICAL FIELD

Embodiments described herein generally include techniques to perform mitigation operations for back-end bound high latency instructions.

### BACKGROUND

Determining the more frequently executed portions of a program is often done through a process known as profiling. Profile-guided optimization is a compiler technique that, based on the profile feedback, selects a portion of a program as important, and optimizes that portion of the program aggressively. However, profile-guided optimization fails to adequately detect cache miss penalties that happen along different code paths. Even if load/store information were collected (e.g., by Emon), its incisiveness is curtailed due to averaging effects, and, if code profiles (e.g., from Vtune) are used to assess which paths have how many cache misses, it is still difficult to associate the marginal contribution of cache misses to the cycles-per-instruction metric.

### BRIEF DESCRIPTION OF THE DRAWINGS

FIG. 1 illustrates an example of a system.

FIG. 2 illustrates an example of a processing flow.

FIG. 3A-3C illustrates an example of a flow diagram.

FIG. 4 illustrates an example of a logic flow diagram.

FIG. 5 illustrates an example embodiment of a computing architecture.

### DETAILED DESCRIPTION

Embodiments may generally be directed to optimizations that may be performed by a compiler to mitigate back-end bound penalties, such as cache miss penalties that may happen along different execution paths. Moreover, embodiments may be directed to towards identifying high latency loads that occur in high clock-ticks per instruction (CPI) execution paths. As will be discussed in more detail below, one or more embodiments may focus on frequent sequences of basic blocks of instruction where both proportionally more time gets spent, and proportionally higher penalty cache misses occur. With this focus, the compiler optimizations and mitigation process can focus on a critical subset of back-end bound behaviors.

In one example, a compiler may compile source code including one or more basic blocks of instructions and generate a binary or one or more binary files. The compiler may perform optimizations on the binary. For example, the compiler may execute the binary as part of a code optimization routine to identify portions of the source code including the basic blocks of instructions that may be causing back-end bound behavior. The compiler may identify a path of execution of a plurality of the basic blocks of instructions having a higher execution frequency than an execution frequency threshold and collect last branch records (LBRs) for the plurality of the basic blocks of instructions in the path of execution, for example. The last branch records indicate times of execution for the plurality of the basic blocks of instructions. In embodiments, the compiler may determine latency values for each of the plurality of the basic blocks of instructions based on the times of execution in the LBRs and perform a mitigation operation for each of the plurality of the basic blocks of instruction having latency values above a latency threshold. The mitigation operation may include one or more of inserting a prefetch instruction, causing an advanced load, reordering the plurality of basic blocks of instruction, and so forth. These and other details will become more apparent in the following description.

Reference is now made to the drawings, wherein like reference numerals are used to refer to like elements throughout. In the following description, for purposes of explanation, numerous specific details are set forth to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

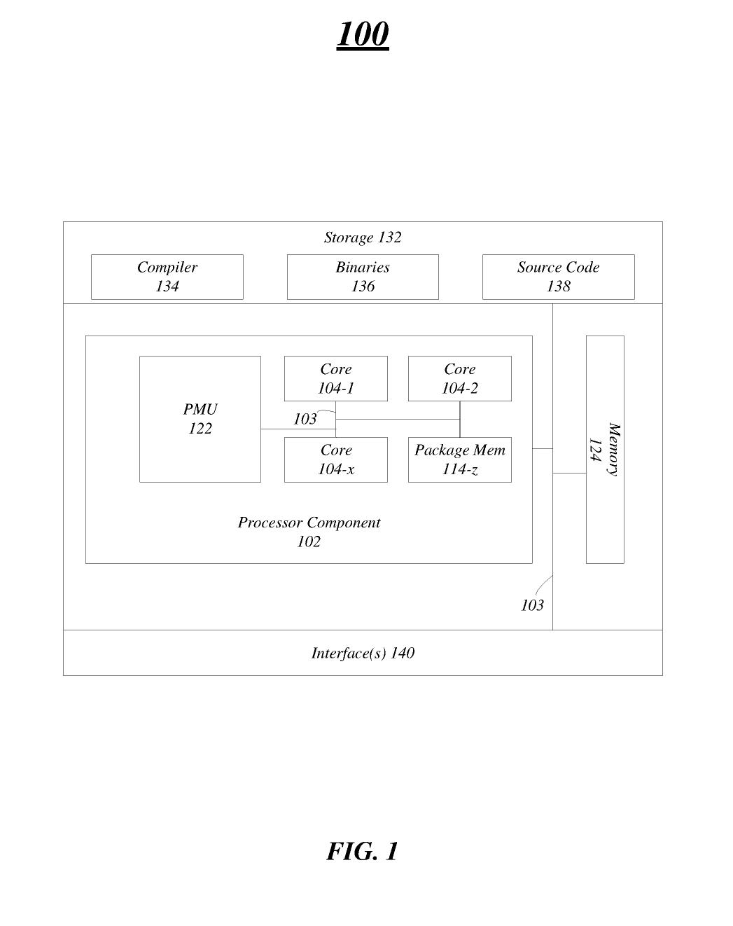

FIG. 1 illustrates an example embodiment of a system 100 in which aspects of the present disclosure may be employed to process data, identify high latency instructions that occur in high frequency execution paths, and perform mitigation operations to reduce the high latency costs. The system 100 may be computing device, such as a personal computer, desktop computer, tablet computer, netbook computer, notebook computer, laptop computer, a mobile computing device, a server, server farm, blade server, a rack-based server, a rack-based processing board, and so forth.

In embodiments, the system 100 includes devices, circuitry, memory, storage, and components to process data and information. In the illustrated example, the system 100 includes a processor component 102 including processing circuitry, which may be a central processing unit (CPU), multi-component packet (MCP), or the like. The processor component 102 can include one or more cores 104-x, where x may be any positive integers, and package memory 114-z, where z may be any positive integer. The package memory 114 may be volatile memory, such as cache that can be used by the other components of the processor component 102 to process information and data.

The system 100 may include other components, such as a performance monitoring unit (PMU) 122, memory 124 and one or more interfaces 140. The PMU 122, the memory 124, and the one or more interfaces 140 may be coupled via one or more interconnects 103. The memory 124 may be one or more of volatile memory including random access memory (RAM) dynamic RAM (DRAM), static RAM (SRAM), double data rate synchronous dynamic RAM (DDR SDRAM), SDRAM, DDR1 SDRAM, DDR2 SDRAM, SSD3 SDRAM, single data rate SDRAM (SDR SDRAM), DDR3, DDR4, and so forth. Embodiments are not limited in this manner, and other memory types may be contemplated and be consistent with embodiments discussed herein. For example, the memory 124 may be a three-dimensional crosspoint memory device, or other byte addressable write-in-place nonvolatile memory devices. In embodiments, the memory devices may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory based device, a magnetic tunneling junction (MTJ) based device, a DW (Domain Wall) and SOT (Spin-Orbit Transfer) based device, a thyristor-based memory device, or a combination of any of the above, or other memory.

In embodiments, the system 100 includes one or more interface(s) 140 to communicate data and information with other compute systems, for example. An interface 140 may be capable of communicating via a fabric network or an Ethernet network, optically and/or electrically. Examples of an interface 140 include a Universal Serial Bus (USB) ports/adapters, IEEE 1394 Firewire ports/adapters, and so forth. Additional examples of interfaces 140 include parallel interfaces, serial interfaces, and bus interfaces. Embodiments are not limited in this manner.

The system 100 includes storage 132, such as non-volatile storage, which may further include an operating system (not shown) or system software that manages the system's 100 hardware and software resources and to provide common services for computer programs, software applications, and hardware components. The operating system 130 may be a Windows® based operating system, an Apple® based on operating system, a Unix® based operating system, and so forth.

The storage 132 further includes a compiler 134, binaries 136, source code 138 having one or more basic blocks of instructions, and other software, such as applications. The compiler 134 includes a program or set of programs to translate source text/code 138 into target text/code, such as the binaries 136. In some instances, the compilation of source code 138 with the compiler 134 is done in multiple phases and passes to transform hi-level programming language code into low-level machine or assembly language code, e.g., binaries 136. The compiler may utilize any compilation techniques and perform any compiler operations, such as lexical analysis, preprocessing, parsing, semantic analysis, code generation, code transformation, and code optimization. The compiler 134 may compile and optimize code to insert operations, calls, functions, instructions, etc. to perform the methods described herein. Such optimizations occur during static and/or whole program compilation. In other instances, optimizations may occur during dynamic compilation.

In embodiments, the compiler 134, to perform optimizations, may perform profiling of program execution of a binary 136 with event-triggered last branch records (LBRs) collection. The LBRs provide branch trace information through special bus cycles on the system bus or through records to a user-defined memory buffer and indicate times of execution for a previous specified number of basic blocks of instructions, e.g., the last 32 records, based on a triggering event. Moreover, an event to trigger an LBR collection may include a memory latency load time greater than a memory latency load threshold (latency greater than 32 clock cycles), a processor cache miss event (L2 misses, L3 miss), and so forth. Other possible triggers may be a number of instructions retired, a number of branches that have been mispredicted, and so forth. For example, the triggering may occur when a number of cache miss events (meets or) exceeds a cache miss events threshold, a number of instructions (meets or) exceeds an instruction count threshold, and a number of branches that are mispredicted (meets or) exceeds a mispredicted branches threshold. Each of the thresholds, the memory latency load threshold, the cache miss events threshold, the instruction count threshold, and the mispredicted branches threshold may be set by a user or processing circuitry based on a number of records required to accurately perform the optimizations. Processor's performance monitoring unit (PMU) may be programmed with a “Sample After Value” which specifies the number of events of the desired type that are allowed to occur before the LBR collection is triggered. The event-based sampling enables narrow casting of timed-LBR collection instead of collecting every timed LBR path. Thus, embodiments focus on timed-LBR sequences that are sampled as triggered by the one or more events.

Further, the compiler 134 may utilize the timed LBRs to determine basic block of instructions that have high clock-ticks per instruction (CPI) or clock cycle counts. Thus, the compiler 134 may select those basic block of instructions that have a high CPI, e.g., a latency value above a latency threshold. One or more mitigation operations may be performed to optimize the source and binary and may include inserting a prefetch instruction into a basic block instruction, causing an advanced load, reordering the basic blocks of instruction, and so forth. Embodiments are not limited in this manner.

In embodiments, the compiler 134 may perform one or more mitigation operations, and optimizations based on the identified heavily executed paths of execution and collected LBRs and recompile the source code 138 associated with the binary 136 on which the optimization is performed. The recompiled binaries may include the optimizations including inserted prefetch instructions, advanced loading instructions, and/or reordering of basic blocks of instruction.

In embodiments, the compiler 134 may perform these optimizations for any number of paths of executions identified as having a high frequency of execution and including basic blocks of instruction with high latency values. Embodiments are not limited in this manner.

In embodiments, the system 100 may also include a performance monitoring unit (PMU) 122 capable of detecting and measuring performance parameters, such as instruction cycles, cache hits, cache misses, branch misses, and so forth. In some embodiments, the PMU 122 may be integrated as part of the processor component 102; however, embodiments are not limited in this manner. In embodiments, the processor component 102 may include more than one PMU 122. For example, a processor component 102 may include a PMU 122 for each of the cores 104-x.

The PMU 122 includes circuitry and registers, such as model specific registers (MSRs) capable of programming to measure events and measuring the events. In embodiments, a register of the PMU 122 is set to enable event-based sampling to track an event. In some embodiments, more than one event may be tracked by the PMU 122 by setting one or more of the registers. An event tracked by the PMU 122 may include a memory latency load greater than a memory latency load threshold (e.g., memory latency loads greater than 32 clocks), a memory miss event, a branch miss event, and so forth. The PMU 122 may be configured to detect one or more of the events by software, such as a compiler 134, or another component of the system 100.

In embodiments, the PMU 122 may collect profile information to determine precise instruction profiling, execution latency values for basic block of instructions, and event-based triggering. In embodiments, the PMU 122 may collect LBRs based on the triggering of an event, for example. The LBRs collected by PMU 122 may be a last number of basic block of instructions executed before the triggering of the event, e.g., the last 32 records prior to the triggering of the event. Embodiments are not limited to this example, and the number of records collected may be configurable, e.g., set by the compiler 134 via a register of the PMU 122.

In embodiments, the LBRs may include time stamps for each of the basic block entry and exit points in the LBR stack. The LBRs collected based on a triggering event may be saved in a register and retrieved by the compiler 134 to perform optimization and mitigation operations. For example, the compiler 134 may use the execution time for each of the basic blocks to estimate the execution latency values for the basic block of instructions. These latency values may be utilized to determine basic block of instructions having a high CPI.

The PMU 122 may collect additional profiling information including identify paths of execution (“hot paths”) having a higher execution frequency than an execution frequency threshold based on edge frequencies and basic-block-counts. By utilizing the event-based triggering, the PMU 122 can provide a large sample set of LBR records that are concentrated along those regions or paths identified as having a high execution frequency and are of performance optimization interest. Moreover, utilizing precise instruction profiling, execution latency values for basic block of instructions, and event-based triggering enables the compiler 134 to perform mitigation operations dynamically and the ability to target specific processor optimizations for applications.

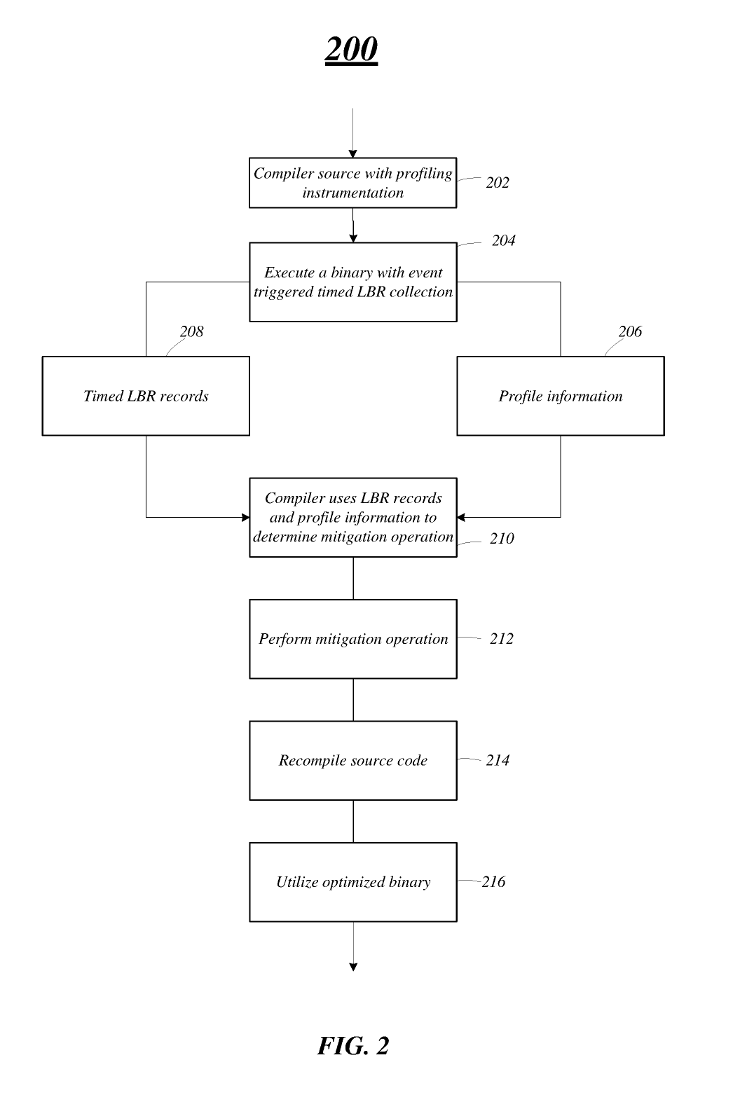

FIG. 2 illustrates an example of a processing flow 200 that may be representative of some or all the operations executed by one or more embodiments described herein. For example, the processing flow 200 may illustrate operations performed by a compiler 134 and a PMU 122. However, embodiments are not limited in this manner, and one or more other components may perform operations to enable and support the operations discussed in this processing flow 200.

At block 202, the processing flow 200 includes a compiler translating source text/code into target text/code utilizing any compilation techniques and code optimization with profiling instrumentation enabled. The compiler 134 executes a binary with event-triggered time LBR collection to optimize code to insert operations, calls, functions, instructions, etc. at block 204. Information and data may be collected by the PMU 122 and provided to the compiler 134 to optimize code during execution of the binary.

More specifically, the compiler 134 may receive profile information and timed LBR records at blocks 206 and 208, respectively, from the PMU 122 which is collected during execution of the binary. The PMU 122 may collect profile information to determine precise instruction profiling, execution latency values for basic block of instructions, and event-based triggering, as previously discussed. For example, the PMU 122 may collect LBRs based on the triggering of an event. The LBRs collected by the PMU 122 may be a last number of basic block of instructions executed prior to the triggering of the event, e.g., the last 32 records prior to the triggering of the event. The LBRs may be set in a register and of the PMU 122 and retrieved or received by the compiler 134.

The PMU 122 may collect additional profiling information based on “hot” paths of execution identified by programmer or analyst. A “hot” path of execution refers to paths that are executed with a higher overall frequency of execution than a specified threshold rate that a programmer or analyst may select as representative of a normal code path. Programmers may select a normal frequency threshold in many ways—for example, they may identify first the total number of basic blocks executed (taking a sum across all executed blocks the number of times each executed) as a base rate, and from there select a threshold that is say 4 times that base rate, and then identify all sequences basic blocks which each exceed this threshold. These collections along with the edges that are in those sequences constitute hot paths. The additional profiling information may also be provided to the compiler 134.

At block 210, the logic flow 200 includes determining one or more mitigation operations to perform based on the LBR records and the profile information. As previously discussed, the LBRs may include basic block execution times for each of the basic block of instructions in the LBR. The compiler 134 may use the execution times for each of the basic blocks to determine the execution latency values for the basic block of instructions. These latency values may be utilized to determine basic block of instructions having a high CPI. Further, the compiler 134 may use the latency values and the paths of execution identified as having a high execution frequency, e.g., paths having higher execution frequency than an execution frequency threshold, to determine one or more mitigation operations to perform. For example, the compiler 134 may identify basic blocks of instructions having high latency values along high-frequency paths of execution to perform mitigation operations.

At block 212, the logic flow 200 includes performing the one or more mitigation operations. A mitigation operation may include inserting a prefetch instruction, causing an advanced load, and reordering the plurality of basic blocks of instruction. For example, the compiler 134 may determine a basic block of instructions having a high latency value in an execution path caused by cache misses. The compiler 134 may insert a prefetch instruction in a previous basic block in the path of execution after resolving any possible read or write dependencies, such that the value causing the back-end blockage is prefetched, effectively reducing the latency of execution. Note that basic block of instruction receiving the prefetch instruction may be inserted in any basic block proceeding the basic block having the high latency. In one example, a brute force method may be used to insert the pre-fetch instruction into every basic block that can enter the basic block having a high latency value. In another example, the profile information may be used to choose one or more basic blocks along the most frequent path that enters the basic block having the high latency to insert the prefetch instruction. The mitigation operation may be performed on the source code associated with the executed binary. The compiler 134 may recompile the source code at block 214 to generate a new binary including the results of the mitigation operations, and the new binary may be utilized at block 216, e.g., executed.

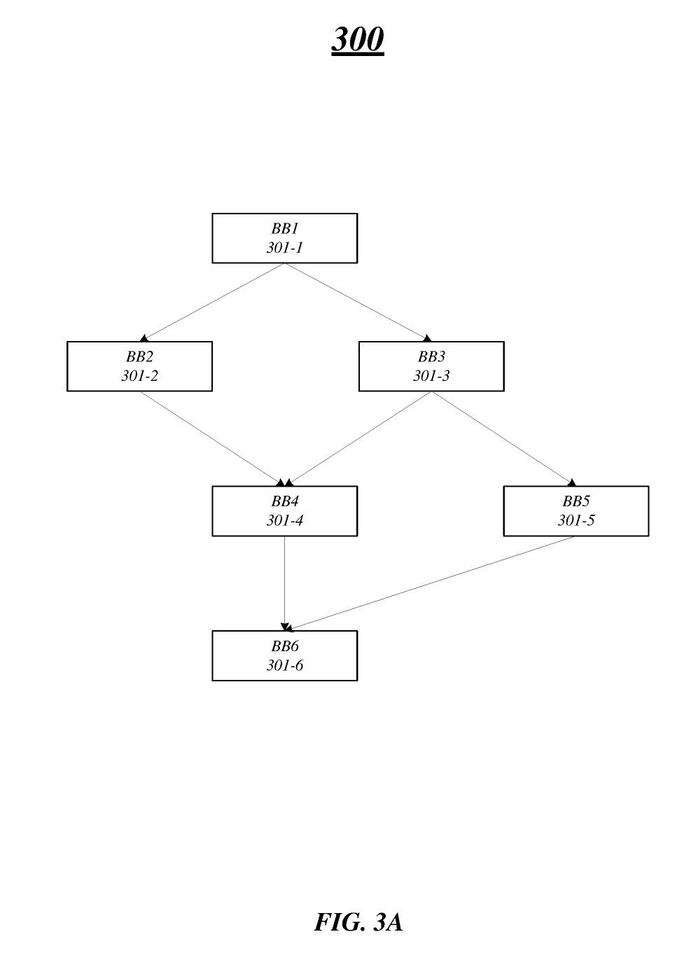

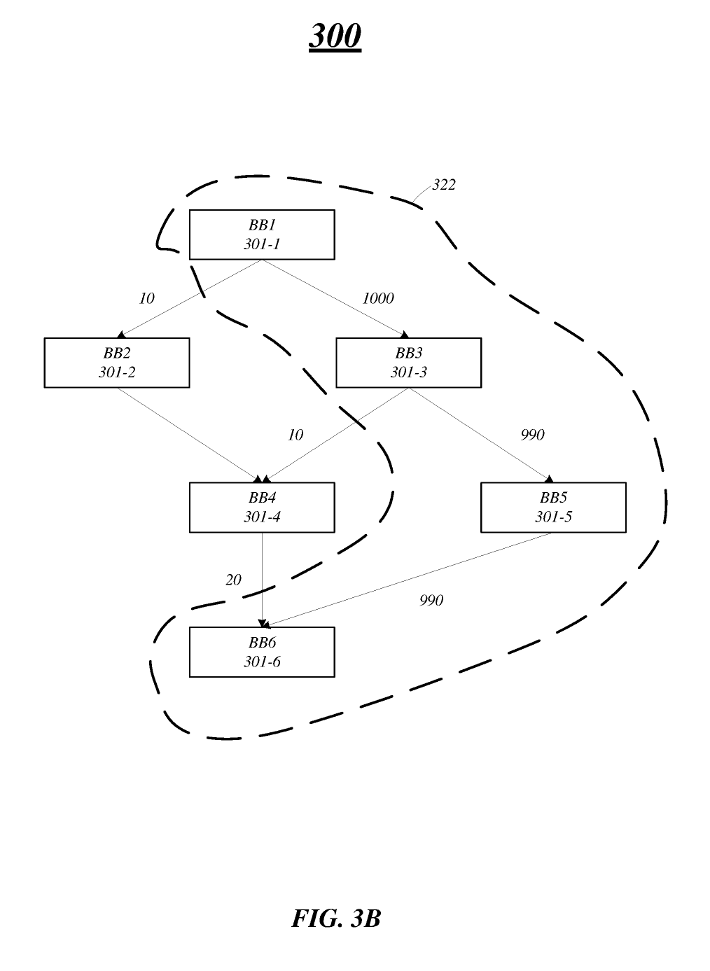

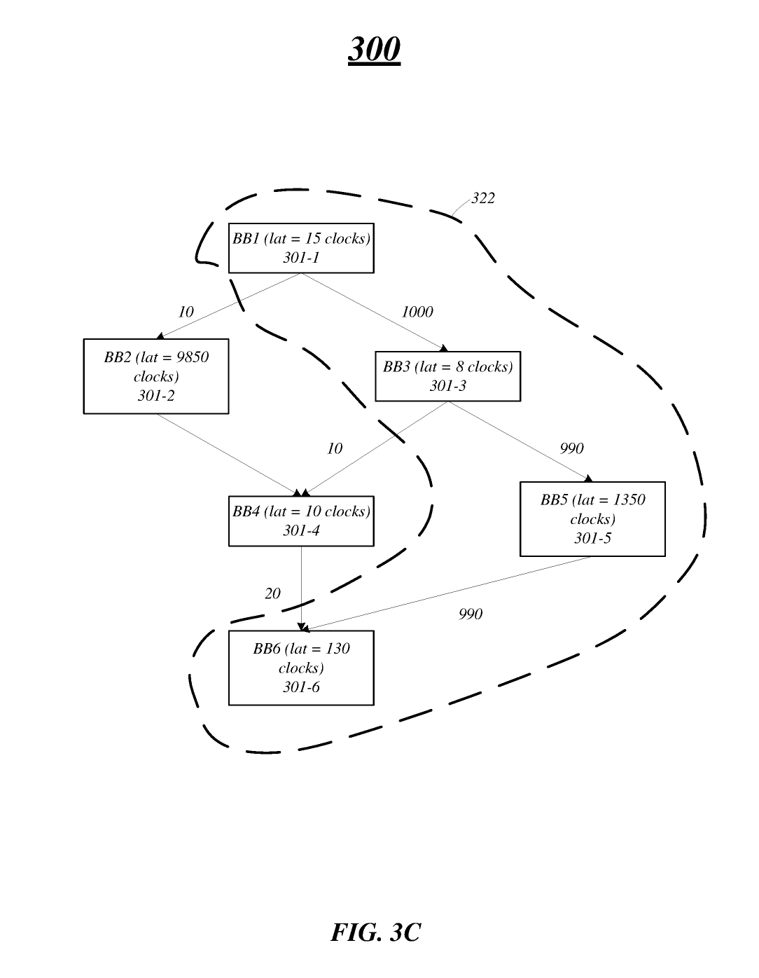

FIGS. 3A-3C illustrate a control flow diagram 300 including a number of basic blocks of instructions 301-1 through 301-6 that may be part of a binary executed for code optimizations. In embodiments, a basic block of instruction may be a straight-line code sequence with no branches except upon entry and exit, as illustrated in diagram 300. For example, upon exiting basic block of instruction (BB1) 301-1, the path of execution may either go to BB2 301-2 or BB3 301-3. Similarly, BB4 301-4 may be entered either from BB2 301-2 or BB3 301-3. However, the execution path is straight within each of the BBs 301. The compiler 134 may decompose a binary 136 into the basic blocks of instructions 301 which tend to be highly amenable to analysis. In the illustrated diagram 300, the basic blocks of instructions 301 form the nodes and the links or edges form the various paths of execution between the basic blocks of instructions 301.

In embodiments, a binary may be executed, and the compiler 134 and the PMU 122 may determine information about each of the basic blocks of instruction 301. For example, the PMU 122 may collect profiling information and LBRs for the basic blocks of instruction 301. The profiling information may indicate one or more highly utilize paths of execution, e.g., those paths of execution which are executed above an execution frequency threshold and have a higher execution frequency. The execution frequency threshold may be a percentage, such as 50%. In this example, paths of execution that are executed (at or) above 50% of the total time of execution may be considered a highly utilized path of execution. Embodiments are not limited in this manner, and the percentage may be configurable by the compiler 134 or a user. In another example, the execution frequency threshold may be a number value out of a total possible number, e.g., 1000 out of 1010 possible executions the path of execution may follow a particular edge. Similarly, the number value may also be configurable by the compiler 134 or a user.

FIG. 3B illustrates the control diagram 300 indicating a highly utilized path of execution 322, which includes BB1 301-1, BB3 301-3, BB5 301-5, and BB6 301-6. The diagram 300 also illustrates a number value for each link between each of the basic blocks of instruction (BBs) 301 indicating a number of times the link was followed as the path of execution during execution of the binary. For example, the path of execution may have gone from BB1 301-1 to BB2 301-2 ten (10) times while the path of execution may have gone from BB1 301- to BB3 301-3 a thousand (1000) times. Thus, as seen from the number values associated with the links, the path of execution 322 including BB1 301-1, BB3 301-3, BB5 301-5, and BB6 301-6, was highly utilized compared to other possible paths of execution. Note that the illustrated example only indicates a single path as a highly utilized path of execution; however, embodiments are not limited in this manner. Any number of paths of executions may be considered highly utilized, which may be determined and based on the execution frequency threshold.

The compiler 134 may receive the LBRs with times of execution for each of the basic blocks of instruction 301. The compiler 134 may determine latency values or clock-ticks for each of the basic blocks of instruction 301 based on the times of execution. FIG. 3C illustrates each of the basic blocks of instruction 301 having an associated latency (lat) value indicating a number of clock-ticks to process a respective basic block 301. As illustrated in FIG. 3C, the latency value for BB1 301 is 15 clock-ticks, the latency value for BB3 301-3 is 8 clock-ticks, the latency value for BB5 is 1350 clock-ticks, and the latency value for BB6 is 130 clock-ticks for the heavily utilized path of execution 322.

The compiler 134 may identify basic blocks of instruction 301 along the highly utilized path of execution having high latency values. For example, the compiler 134 may determine basic blocks of instruction 301 having latency values greater (and/or equal) than a latency threshold. The latency threshold may be a specified number of clock-ticks or a percentage value of the total number of clock-ticks. The compiler 134 may utilize the profiling and the latency values to determine one or more mitigation operations or optimizations to perform to mitigate the high latencies along the highly utilized path of execution. In the illustrated example, the compiler 134 may identify BB5 301-5 as having a high latency value (lat=1350) based on the latency value being greater than (or equal) to a latency threshold and along the highly utilized path of execution 322. The compiler 134 may determine to perform a mitigation operation, such as inserting a prefetch instruction in BB1 301-1 to accelerate data consumption during actual execution.

In some embodiments, the compiler 134 may perform mitigation operations for basic blocks of instruction having high latency values along the highly utilized path of execution. However, embodiments are not limited in this manner. In some instances, the compiler 134 may identify every basic blocks of instruction having high latency values, e.g., a latency value above (or equal) to the latency threshold. In the illustrated example, the compiler 134 may identify BB2 301-2 as having a high latency value (lat=9850). The compiler 134 may determine to perform a mitigation operation for BB2 301-2, which may include inserting a prefetch instruction BB1 301-1 for BB2 301-2. Embodiments are not limited to these examples.

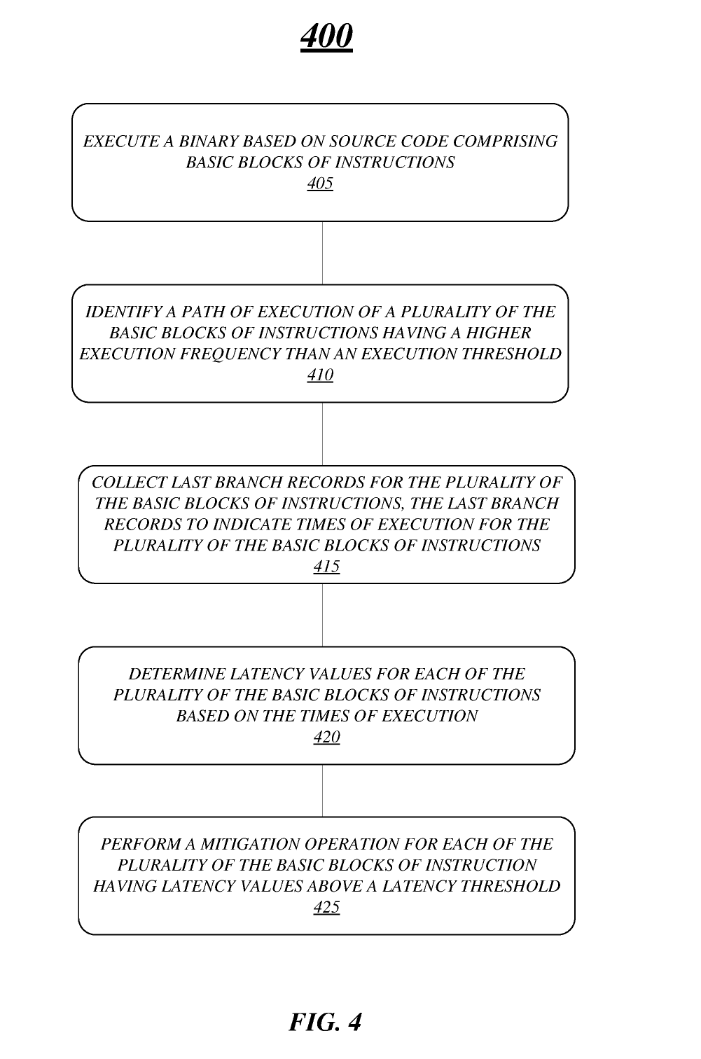

FIG. 4 illustrates an example of a logic flow 400 that may be representative of some or all of the operations executed by one or more embodiments described herein. For example, the logic flow 400 may illustrate operations performed by a system including components such as a PMU and compiler, as described herein.

At block 405, the logic flow 400 may include executing a binary based on source code comprising basic blocks of instructions. The binary may be generated by a compiler using the source code comprising the basic blocks of instructions, for example. Moreover, the compiler may execute the binary as part of a code optimization routine to identify portions of the source code including the basic blocks of instructions that may be causing problems, such as high latency times.

The logic flow 400 includes identifying a path of execution of a plurality of the basic blocks of instructions having a higher execution frequency than execution frequency threshold at block 410. For example, the compiler may receive profile information from the PMU that may indicate a number of times a link or path between each of the basic blocks of instructions is traversed. The compiler may determine one or more paths of execution that are utilized more than other paths of execution. The execution frequency threshold may be an integer value, a percentage of use, and so forth.

At block 415, the logic flow 400 includes collecting last branch records (LBRs) for the plurality of the basic blocks of instructions, the last branch records to indicate times of execution for the plurality of the basic blocks of instructions. In embodiments, the LBRs may be collected by the compiler from the PMU based on a triggering event. The triggering of the event may include one of a memory latency load greater than a memory latency load threshold, a memory miss event, a branch miss event, and so forth. Each time an event is triggered, the PMU may collect a previous number of LBRs, e.g. 32 records, and store the information in a register that may be read by the compiler. The compiler may utilize the LBRs including the times of execution for the basic blocks of instructions to determine latency values for basic blocks. More specifically, at block 420, the logic flow 400 includes determining latency values for each of the plurality of the basic blocks of instructions based on the times of execution. The latency values may be based on the LBR collection, which may include a sampling of entry and exit times through basic blocks. An average across the samplings may be determined and used for the latency values for the basic blocks.

At block 425, embodiments include performing a mitigation operation for each of the plurality of the basic blocks of instruction having latency values above a latency threshold. The mitigation operation may include one or more inserting a prefetch instruction, causing an advanced load, reordering the plurality of basic blocks of instruction, and so forth. Embodiments are not limited in this manner.

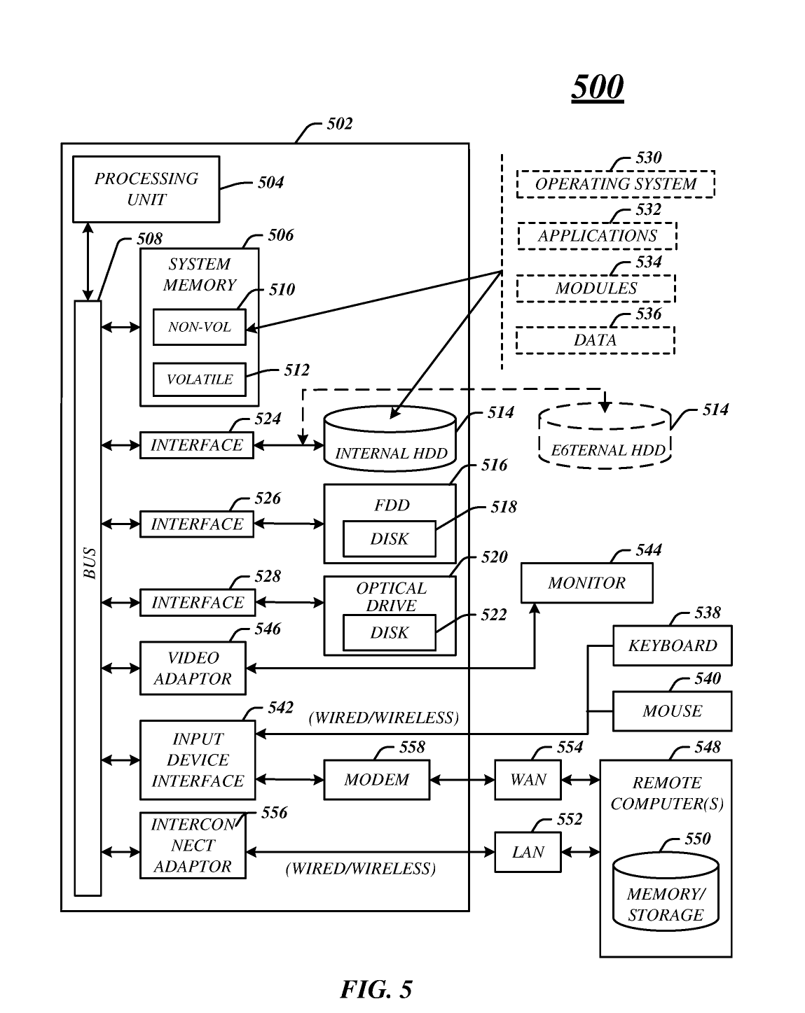

FIG. 5 illustrates an embodiment of an exemplary computing architecture 500 suitable for implementing various embodiments as previously described. In embodiments, the computing architecture 500 may include or be implemented as part of a node, for example.

As used in this application, the terms “system” and “component” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and thread of execution, and a component can be localized on one computer and distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes a processing unit 504, a system memory 506 and a system bus 508. The processing unit 504 can be any of various commercially available processors.

The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures. Interface adapters may connect to the system bus 508 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 5, the system memory 506 can include non-volatile memory 510 and volatile memory 512. A basic input/output system (BIOS) can be stored in the non-volatile memory 510.

The computer 502 may include various types of computer-readable storage media in the form of one or more lower speed memory units, including an internal (or external) hard disk drive (HDD) 514, a magnetic floppy disk drive (FDD) 516 to read from or write to a removable magnetic disk 516, and an optical disk drive 520 to read from or write to a removable optical disk 522 (e.g., a CD-ROM or DVD). The HDD 514, FDD 516 and optical disk drive 520 can be connected to the system bus 508 by an HDD interface 524, an FDD interface 526 and an optical drive interface 526, respectively. The HDD interface 524 for external drive implementations can include at least one or both of Universal Serial Bus (USB) and IEEE 1394 interface technologies.

The drives and associated computer-readable media provide volatile and nonvolatile storage of data, data structures, computer-executable instructions, and so forth. For example, a number of program modules can be stored in the drives and memory units 510, 512, including an operating system 530, one or more application programs 532, other program modules 534, and program data 536. In one embodiment, the one or more application programs 532, other program modules 534, and program data 536 can include, for example, the various applications and components of the system 100.

A user can enter commands and information into the computer 502 through one or more wire/wireless input devices, for example, a keyboard 536 and a pointing device, such as a mouse 540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. The monitor 544 may be internal or external to the computer 502. In addition to the monitor 544, a computer typically includes other peripheral output devices, such as speakers, printers, and so forth.

The computer 502 may operate in a networked environment using logical connections via wire and wireless communications to one or more remote computers, such as a remote computer 546. The remote computer 546 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and larger networks, for example, a wide area network (WAN) 554. Such LAN and WAN networking environments are commonplace in offices and companies and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 556, or is connected to a communications server on the WAN 554, or has other means for establishing communications over the WAN 554, such as by way of the Internet. The modem 556, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 502 family of standards, such as wireless devices operatively disposed in wireless communication (e.g., IEEE 502.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 502.116 (a, b, g, n, etc.) to provide secure, reliable, fast wireless connectivity. A Wi-Fi network can be used to connect computers to each other, to the Internet, and to wire networks (which use IEEE 502.3-related media and functions).

The various elements of the devices as previously described with reference to FIGS. 1-5 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty-three provided below are intended to be exemplary and non-limiting.

In a first example, a system, a device, an apparatus, and so forth may include memory storing instructions, and processing circuitry coupled with the memory, the processing circuitry operable to execute the instructions, that when executed, enable processing circuitry to execute a binary based on source code comprising basic blocks of instructions, identify a path of execution of a plurality of basic blocks of instructions having a higher execution frequency than an execution frequency threshold, collect last branch records for the plurality of the basic blocks of instructions, the last branch records to indicate times of execution for the plurality of the basic blocks of instructions, determine latency values for each of the plurality of the basic blocks of instructions based on the times of execution, and perform a mitigation operation for each of the plurality of the basic blocks of instruction having latency values above a latency threshold.

In a second example and in furtherance of the first example, the system, the device, the apparatus, and so forth including the processing circuitry to identify the path of execution based on edge frequencies and basic-block-counts for each of the plurality of the basic blocks of instructions.

In a third example and in furtherance of any previous example, the system, the device, the apparatus, and so forth including the processing circuitry to process the last branch records collected based on triggering of an event comprising one of a memory latency load greater than a memory latency load threshold, a memory miss event, a number of instructions, and a number of branches that are mispredicted.

In a fourth example and in furtherance of any previous example, the system, the device, the apparatus, and so forth including the processing circuitry to process the latency value for a basic block of instructions to indicate a number of clock cycles to complete execution of the basic block of instructions.

In a fifth example and in furtherance of any previous example, the system, the device, the apparatus, and so forth including the processing circuitry to process each of the mitigation operations comprising one of inserting a prefetch instruction, causing an advanced load, and reordering the plurality of basic blocks of instruction.

In a sixth example and in furtherance of any previous example, the system, the device, the apparatus, and so forth including the processing circuitry to recompile the source code associated with the binary to generate a recompiled binary, the recompiled binary to include optimizations based on the mitigation operations.

In a seventh example and in furtherance of any previous example, the system, the device, the apparatus, and so forth including the processing circuitry to process each of the optimizations comprising one of a prefetch instruction in the binary, an advanced load instruction in the binary, and the plurality of basic blocks of instruction reordered.

In an eighth example and in furtherance of any previous example, the system, the device, the apparatus, and so forth including the processing circuitry to identify another path of execution of another plurality of the basic blocks of instructions having a higher execution frequency than other paths of execution, collect last branch records for the another plurality of the basic blocks of instructions, the last branch records to indicate times of execution for the another plurality of the basic blocks of instructions, determine latency values for each of the another plurality of the basic blocks of instructions based on the times of execution, and perform a mitigation operation for each of the another plurality of the basic blocks of instruction having latency values above the latency threshold.

In a ninth example and in furtherance of any previous example, the system, the device, the apparatus, and so forth including storage coupled with the memory and the processing circuitry, the storage to store the binary and source code.

In a tenth example and in furtherance of any previous example, a non-transitory computer-readable storage medium, comprising a plurality of instructions, that when executed, enable processing circuitry to execute a binary based on source code comprising basic blocks of instructions, identify a path of execution of a plurality of the basic blocks of instructions having a higher execution frequency than an execution frequency threshold, collect last branch records for the plurality of the basic blocks of instructions, the last branch records to indicate times of execution for the plurality of the basic blocks of instructions, determine latency values for each of the plurality of the basic blocks of instructions based on the times of execution, and perform a mitigation operation for each of the plurality of the basic blocks of instruction having latency values above a latency threshold.

In an eleventh example and in furtherance of any previous example, a non-transitory computer-readable storage medium, comprising a plurality of instructions, that when executed, enable processing circuitry to identify the path of execution based on edge frequencies and basic-block-counts for each of the plurality of the basic blocks of instructions.

In a twelfth example and in furtherance of any previous example, wherein the last branch records collected based on triggering of an event comprising one of a memory latency load greater than a memory latency load threshold, a number of cache miss events exceeding a cache miss events threshold, a number of instructions exceeding an instruction count threshold, and a number of branches that are mispredicted exceeding a mispredicted branches threshold.

In a thirteenth example and in furtherance of any previous example, wherein the latency value for a basic block of instructions to indicate a number of clock cycles to complete execution of the basic block of instructions.

In a fourteenth example and in furtherance of any previous example, wherein each of the mitigation operations comprising one of inserting a prefetch instruction, causing an advanced load, and reordering the plurality of basic blocks of instruction.

In a fifteenth example and in furtherance of any previous example, a non-transitory computer-readable storage medium, comprising a plurality of instructions, that when executed, enable processing circuitry to recompile the source code associated with the binary to generate a recompiled binary, the recompiled binary to include optimizations based on the mitigation operations.

In a sixteenth example and in furtherance of any previous example, wherein each of the optimizations comprising one of a prefetch instruction in the binary, an advanced load instruction in the binary, and the plurality of basic blocks of instruction reordered.

In a seventeenth example and in furtherance of any previous example, a non-transitory computer-readable storage medium, comprising a plurality of instructions, that when executed, enable processing circuitry to identify another path of execution of another plurality of the basic blocks of instructions having a higher execution frequency than other paths of execution, collect last branch records for the another plurality of the basic blocks of instructions, the last branch records to indicate times of execution for the another plurality of the basic blocks of instructions, determine latency values for each of the another plurality of the basic blocks of instructions based on the times of execution, and perform a mitigation operation for each of the another plurality of the basic blocks of instruction having latency values above the latency threshold.

In an eighteenth example and in furtherance of any previous example, a computer-implemented includes executing a binary based on source code comprising basic blocks of instructions, identifying a path of execution of a plurality of the basic blocks of instructions having a higher execution frequency than an execution frequency threshold, collecting last branch records for the plurality of the basic blocks of instructions, the last branch records to indicate times of execution for the plurality of the basic blocks of instructions, determining latency values for each of the plurality of the basic blocks of instructions based on the times of execution, and performing a mitigation operation for each of the plurality of the basic blocks of instruction having latency values above a latency threshold.

In a nineteenth example and in furtherance of any previous example, a computer-implemented includes identifying the path of execution based on edge frequencies and basic-block-counts for each of the plurality of the basic blocks of instructions.

In a twentieth example and in furtherance of any previous example, wherein the last branch records collected based on triggering of an event comprising one of a memory latency load greater than a memory latency load threshold, a number of cache miss events exceeding a cache miss events threshold, a number of instructions exceeding an instruction count threshold, and a number of branches that are mispredicted exceeding a mispredicted branches threshold.

In a twenty-first example and in furtherance of any previous example, wherein the latency value for a basic block of instructions to indicate a number of clock cycles to complete execution of the basic block of instructions

In a twenty-second example and in furtherance of any previous example, wherein each of the mitigation operations comprising one of inserting a prefetch instruction, causing an advanced load, and reordering the plurality of basic blocks of instruction.

In a twenty-third example and in furtherance of any previous example, a computer-implemented includes recompiling the source code associated with the binary to generate a recompiled binary, the recompiled binary to include optimizations based on the mitigation operations.

In a twenty-four example and in furtherance of any previous example, wherein each of the optimizations comprising one of a prefetch instruction in the binary, an advanced load instruction in the binary, and the plurality of basic blocks of instruction reordered.

In a twenty-fifth example and in furtherance of any previous example, a computer-implemented includes identifying another path of execution of another plurality of the basic blocks of instructions having a higher execution frequency than other paths of execution, collecting last branch records for the another plurality of the basic blocks of instructions, the last branch records to indicate times of execution for the another plurality of the basic blocks of instructions, determining latency values for each of the another plurality of the basic blocks of instructions based on the times of execution, and performing a mitigation operation for each of the another plurality of the basic blocks of instruction having latency values above the latency threshold.

In a twenty-sixth example and in furtherance of any previous example, an apparatus or system includes means for identifying another path of execution of another plurality of the basic blocks of instructions having a higher execution frequency than other paths of execution, means for collecting last branch records for the another plurality of the basic blocks of instructions, the last branch records to indicate times of execution for the another plurality of the basic blocks of instructions, means for determining latency values for each of the another plurality of the basic blocks of instructions based on the times of execution, and means for performing a mitigation operation for each of the another plurality of the basic blocks of instruction having latency values above the latency threshold.

In a twenty-seventh example and in furtherance of any previous example, an apparatus or system includes means for identifying the path of execution based on edge frequencies and basic-block-counts for each of the plurality of the basic blocks of instructions.

In a twenty-eighth example and in furtherance of any previous example, wherein the last branch records collected based on triggering of an event comprising one of a memory latency load greater than a memory latency load threshold, a memory miss event, a number of instructions, and a number of branches that are mispredicted.

In a twenty-ninth example and in furtherance of any previous example, wherein the latency value for a basic block of instructions to indicate a number of clock cycles to complete execution of the basic block of instructions.

In a thirtieth example and in furtherance of any previous example, wherein each of the mitigation operations comprising one of inserting a prefetch instruction, causing an advanced load, and reordering the plurality of basic blocks of instruction.

In a thirty-first example and in furtherance of any previous example, an apparatus or system includes means for recompiling the source code associated with the binary to generate a recompiled binary, the recompiled binary to include optimizations based on the mitigation operations.

In a thirty-second example and in furtherance of any previous example, wherein each of the optimizations comprising one of a prefetch instruction in the binary, an advanced load instruction in the binary, and the plurality of basic blocks of instruction reordered.

In a twenty-third example and in furtherance of any previous example, an apparatus or system includes means for identifying another path of execution of another plurality of the basic blocks of instructions having a higher execution frequency than other paths of execution, means for collecting last branch records for the another plurality of the basic blocks of instructions, the last branch records to indicate times of execution for the another plurality of the basic blocks of instructions, means for determining latency values for each of the another plurality of the basic blocks of instructions based on the times of execution, and means for performing a mitigation operation for each of the another plurality of the basic blocks of instruction having latency values above the latency threshold.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “including” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
memory to store instructions; and
processing circuitry coupled with the memory, the processing circuitry operable to execute the instructions, that when executed, enable processing circuitry to:
execute a binary based on source code comprising basic blocks of instructions;
identify a path of execution of a plurality of basic blocks of instructions having a higher execution frequency than an execution frequency threshold;
collect last branch records for the plurality of the basic blocks of instructions, the last branch records to indicate times of execution for the plurality of the basic blocks of instructions;
determine latency values for each of the plurality of the basic blocks of instructions based on the times of execution; and
perform a mitigation operation for each of the plurality of the basic blocks of instruction having latency values above a latency threshold.

2. The apparatus of claim 1, the processing circuitry to identify the path of execution based on edge frequencies and basic-block-counts for each of the plurality of the basic blocks of instructions.

3. The apparatus of claim 1, wherein the last branch records collected based on triggering of an event comprising one or more of a memory latency load greater than a memory latency load threshold, a number of cache miss events exceeding a cache miss events threshold, a number of instructions exceeding an instruction count threshold, and a number of branches that are mispredicted exceeding a mispredicted branches threshold.

4. The apparatus of claim 1, wherein the latency value for a basic block of instructions to indicate a number of clock cycles to complete execution of the basic block of instructions.

5. The apparatus of claim 1, wherein each of the mitigation operations comprising one or more of inserting a prefetch instruction, causing an advanced load, and reordering the plurality of basic blocks of instruction.

6. The apparatus of claim 1, the processing circuitry to recompile the source code associated with the binary to generate a recompiled binary, the recompiled binary to include optimizations based on the mitigation operations.

7. The apparatus of claim 6, wherein each of the optimizations comprising one of a prefetch instruction in the binary, an advanced load instruction in the binary, and the plurality of basic blocks of instruction reordered.

8. The apparatus of claim 1, the processing circuitry to:
identify another path of execution of another plurality of the basic blocks of instructions having a higher execution frequency than other paths of execution;
collect last branch records for the another plurality of the basic blocks of instructions, the last branch records to indicate times of execution for the another plurality of the basic blocks of instructions;
determine latency values for each of the another plurality of the basic blocks of instructions based on the times of execution; and
perform a mitigation operation for each of the another plurality of the basic blocks of instruction having latency values above the latency threshold.

9. The apparatus of claim 1, comprising:
storage coupled with the memory and the processing circuitry, the storage to store the binary and source code.

10. A non-transitory computer-readable storage medium, comprising a plurality of instructions, that when executed, enable processing circuitry to:
execute a binary based on source code comprising basic blocks of instructions;
identify a path of execution of a plurality of the basic blocks of instructions having a higher execution frequency than an execution frequency threshold;
collect last branch records for the plurality of the basic blocks of instructions, the last branch records to indicate times of execution for the plurality of the basic blocks of instructions;
determine latency values for each of the plurality of the basic blocks of instructions based on the times of execution; and
perform a mitigation operation for each of the plurality of the basic blocks of instruction having latency values above a latency threshold.

11. The non-transitory computer-readable storage medium of claim 10, comprising a plurality of instructions, that when executed, enable processing circuitry to identify the path of execution based on edge frequencies and basic-block-counts for each of the plurality of the basic blocks of instructions.

12. The non-transitory computer-readable storage medium of claim 10, wherein the last branch records collected based on triggering of an event comprising one or more of a memory latency load greater than a memory latency load threshold, a number of cache miss events exceeding a cache miss events threshold, a number of instructions exceeding an instruction count threshold, and a number of branches that are mispredicted exceeding a mispredicted branches threshold.

13. The non-transitory computer-readable storage medium of claim 10, wherein the latency value for a basic block of instructions to indicate a number of clock cycles to complete execution of the basic block of instructions.

14. The non-transitory computer-readable storage medium of claim 10, wherein each of the mitigation operations comprising one or more of inserting a prefetch instruction, causing an advanced load, and reordering the plurality of basic blocks of instruction.

15. The non-transitory computer-readable storage medium of claim 10, comprising a plurality of instructions, that when executed, enable processing circuitry to recompile the source code associated with the binary to generate a recompiled binary, the recompiled binary to include optimizations based on the mitigation operations.

16. The non-transitory computer-readable storage medium of claim 15, wherein each of the optimizations comprising one of a prefetch instruction in the binary, an advanced load instruction in the binary, and the plurality of basic blocks of instruction reordered.

17. The non-transitory computer-readable storage medium of claim 10, comprising a plurality of instructions, that when executed, enable processing circuitry to:
identify another path of execution of another plurality of the basic blocks of instructions having a higher execution frequency than other paths of execution;
collect last branch records for the another plurality of the basic blocks of instructions, the last branch records to indicate times of execution for the another plurality of the basic blocks of instructions;
determine latency values for each of the another plurality of the basic blocks of instructions based on the times of execution; and
perform a mitigation operation for each of the another plurality of the basic blocks of instruction having latency values above the latency threshold.

18. A computer-implemented method, comprising:
executing a binary based on source code comprising basic blocks of instructions;
identifying a path of execution of a plurality of the basic blocks of instructions having a higher execution frequency than an execution frequency threshold;
collecting last branch records for the plurality of the basic blocks of instructions, the last branch records to indicate times of execution for the plurality of the basic blocks of instructions;
determining latency values for each of the plurality of the basic blocks of instructions based on the times of execution; and
performing a mitigation operation for each of the plurality of the basic blocks of instruction having latency values above a latency threshold.

19. The computer-implemented method of claim 18, comprising identifying the path of execution based on edge frequencies and basic-block-counts for each of the plurality of the basic blocks of instructions.

20. The computer-implemented method of claim 18, wherein the last branch records collected based on triggering of an event comprising one or more of a memory latency load greater than a memory latency load threshold, a number of cache miss events exceeding a cache miss events threshold, a number of instructions exceeding an instruction count threshold, and a number of branches that are mispredicted exceeding a mispredicted branches threshold.

21. The computer-implemented method of claim 18, wherein the latency value for a basic block of instructions to indicate a number of clock cycles to complete execution of the basic block of instructions.

22. The computer-implemented method of claim 18, wherein each of the mitigation operations comprising one or more of inserting a prefetch instruction, causing an advanced load, and reordering the plurality of basic blocks of instruction.

23. The computer-implemented method of claim 18, comprising recompiling the source code associated with the binary to generate a recompiled binary, the recompiled binary to include optimizations based on the mitigation operations.

24. The computer-implemented method of claim 23, wherein each of the optimizations comprising one of a prefetch instruction in the binary, an advanced load instruction in the binary, and the plurality of basic blocks of instruction reordered.

25. The computer-implemented method of claim 18, comprising:
identifying another path of execution of another plurality of the basic blocks of instructions having a higher execution frequency than other paths of execution;
collecting last branch records for the another plurality of the basic blocks of instructions, the last branch records to indicate times of execution for the another plurality of the basic blocks of instructions;
determining latency values for each of the another plurality of the basic blocks of instructions based on the times of execution; and
performing a mitigation operation for each of the another plurality of the basic blocks of instruction having latency values above the latency threshold.
